(19) United States
(12) Patent Application Publication
(10) Pub. No.: US 2013/0084630 A1
(43) Pub. Date: Apr. 4, 2013

(54) QUANTITATIVE MICROFLUIDIC DEVICES

(71) Applicant: DIAGNOSTICS FOR ALL, INC., Cambridge, MA (US)

(72) Inventors: Jason Rolland, Belmont, MA (US); Patrick Beattie, Cambridge, MA (US); Shailendra Kumar, Needham, MA (US)

(73) Assignee: DIAGNOSTICS FOR ALL, INC., Cambridge, MA (US)

(21) Appl. No.: 13/628,336

(22) Filed: Sep. 27, 2012

Related U.S. Application Data
(60) Provisional application No. 61/539,714, filed on Sep. 27, 2011.
(60) Provisional application No. 61/555,977, filed on Nov. 4, 2011.

(51) Int. Cl. G01N 21/78

(52) U.S. Cl. CPC G01N 21/78
USPC 435/287.8; 156/250

(57) ABSTRACT

Described herein are disposable paper-based assay devices for detection and quantitation of analytes in liquid clinical samples, e.g., blood or urine. The devices may be particularly suitable for use in regions of the world where health care infrastructure is absent. The test devices are versatile in that they can be adapted to detect a variety of analytes. The devices are also easy to use and interpret. Typically, all that is needed to conduct an assay is to apply a drop of sample to the indicated location on the device. The devices are typically colorimetric and readable with the naked eye.

### RELATED APPLICATIONS

This application claims the benefit of and priority to U.S. Provisional Patent Application Ser. No. 61/539,714, filed Sep. 27, 2011, and U.S. Provisional Patent Application Ser. No. 61/555,977, filed Nov. 4, 2011, the contents of each of which are hereby incorporated by reference.

### BACKGROUND

Blood tests for monitoring analyte concentration in a sample from a patient are widely available. One example is devices for diagnosing the status of the liver, now a standard part of medical care in developed nations, particularly for individuals who have underlying liver disease or who are taking medications which can cause hepatotoxicity (drug-induced liver injury, or DILI). Medications which can lead to DILI, and the subsequent elevation of serum transaminase (aspartate aminotransferase (AST) and alanine aminotransferase (ALT) levels, include statins, acetaminophen, aspirin, ibuprofen, naproxen, phenylbutazone, anti-seizure medications, antibiotics, and antidepressants. Additionally, conditions such as acute viral hepatitis A or B, alcoholism, drug addiction, liver cancer, shock, liver steatosis or fatty liver, obesity, diabetes, hemochromatosis, Wilson's disease, alpha-1-antitrypsin deficiency, environmental toxin exposure, and Crohn's disease are correlated with increased transaminases and require frequent monitoring.

A specific case of frequent DILI occurs in patients being treated for human immunodeficiency virus (HIV) or tuberculosis (TB). Accordingly, U.S. guidelines call for baseline and serial monitoring of serum transaminases in at-risk individuals while on standard TB and/or HIV therapy. The overall incidence of clinically significant hepatotoxicity on TB therapy (typically due to the medications isoniazid, rifampin, and/or pyrazinamide) ranges from 2-33%, and risk may be increased by multiple factors, such as abnormal baseline transaminases, increasing age, pre-existent liver disease (e.g. hepatitis B and/or C), alcohol use, pregnancy, and malnutrition.

Monitoring for health-related parameters, e.g., for analytes indicative of liver health, via blood or urine tests in resource-limited settings—defined broadly as settings where access to modern equipment and instrumentation is limited—is often prohibited by relative expense and logistical and practical concerns. Testing is often done in centralized or regional laboratories in these settings, resulting often in significant delays in obtaining and acting on results. Because of these obstacles, in many resource-limited settings, patients receive minimal or no monitoring. Low-cost, minimally invasive, point-of-care test devices for analytes of clinical significance would have a dramatic impact on patient care in both the developing and the developed world.

### SUMMARY

A series of methods and structural improvements now have been developed which permit the efficient and extremely inexpensive manufacture of disposable, assay devices for detection and quantitation of analytes in liquid clinical samples, e.g., blood or urine. The test devices are versatile in that they can be adapted to detect a variety of analytes. In use, they are easy to use and are self-actuating: typically all that is needed to conduct the assay is to apply a drop of sample to the indicated location on the device. In addition, they are easy to interpret: typically being colorimetric and readable with the naked eye. Further, they are at least semi-quantitative. These methods and improvements, defined in greater detail below in the context of the design of a disposable, paper-based test for liver function, may be applied to develop a family of colorimetric clinical assay devices suitable for use in regions of the world where health care infrastructure is absent.

In one broad aspect, the invention provides a test device for quantitative determination of an analyte in a liquid biological sample. The device comprises a porous, hydrophilic sheet, e.g. adsorptive paper or nitrocellulose, defining plural functional regions including a liquid sample input; a colorimetric test readout; a negative control that upon absorption of the sample maintains or displays a predetermined color; a positive control, and a liquid flow path which, responsive to application of a liquid sample to the input, transports liquid between the input and both the readout and controls. Disposed in the device, e.g., adjacent the input region or in the test region, or in a reagent reservoir in fluid communication with the liquid flow path, is at least one dried, color-producing reagent arranged to produce a shade or pattern of color in a readout as a function of the concentration of an analyte in the sample. Also disposed in the device is a dried, color-producing reagent which reacts at the positive control to produce color. In these embodiments of devices of the invention, a valid test is indicated by only if there is a color change in the positive control and maintenance or display of a predetermined color at the negative control.

In another aspect, the invention provides a family of test devices for quantitative determination of an analyte in a liquid biological sample which have elements in common with the embodiment described in the previous paragraph, but the colorimetric test readout includes a region of a color backing the readout, e.g., a region of printed color, which optically interacts with color developed at the readout to improve visual discrimination among different analyte concentrations in an applied sample. Thus, this type of device comprises a porous, hydrophilic sheet defining plural functional regions including a liquid sample input; a colorimetric test readout including the region of a color backing the readout which optically interacts with color developed at the readout to improve visual discrimination among different analyte concentrations in an applied sample; a colorimetric control; and a liquid flow path which transports liquid between the input and both the readout and the control. Again, disposed in the device is a dried, color-producing reagent which, responsive to application of a liquid sample to the input, is entrained and reacts with an analyte, if present in the applied sample, to produce a visually detectable change of color (as opposed to an intensity of a single color) in the readout as a function of the concentration of an analyte in the sample.

In preferred embodiments, the device comprises a plurality of sheets disposed parallel to one another, e.g., stacked or laminated, at least two of which are separated by a liquid impermeable barrier layer defining an opening permitting liquid flow communication between the sheets. The color producing reagent may react with any analyte, and in one preferred embodiment, reacts with one or more liver enzymes to detect pathologic liver function such as elevated levels or concentrations of aspartate aminotransferase, alanine aminotransferase, or a mixture thereof. The negative control may comprise a colored area applied to a sheet which has an appearance when wetted different from when dry. The readout may comprise an area of a sheet comprising an immobilized binder which captures a colored species produced by the color-producing reagents. This permits display or a readout of the concentration of analyte in a sample as a portion of the area that develops color responsive to application of liquid to said input. The area may be continuous so that the concentration of analyte in a said sample is indicated, as in a mercury thermometer, by the linear extent of color development in the area. Alternatively, the area comprises a plurality of separate areas and the concentration of analyte in the sample is indicated by the number of areas that develop color.

In still additional forms and embodiments of the invention the device further comprises a region defining a timer comprising a reservoir disposed in the device in liquid communication with the inlet which, after application of a sample, receives liquid from the sample over a predetermined time interval and comprises indicia that the reservoir is filled and the device is ready to be read. The timer may for example comprise a channel of predefined dimensions which determines the length of time that liquid takes to reach the reservoir and to activate the indicia, which may comprise a printed message visible when the device is ready to be read. The timer also may function as a positive colorimetric control. Often, the timer is disposed downstream from the readout. Many of the devices of the invention comprise a filter disposed upstream of the inlet, e.g., to exclude colored components such as red blood cells or hemoglobin from transport through the flow structure of the device and to permit unhindered colorimetric readout.

In yet additional forms and embodiments of the invention the device further comprises downstream of the color-producing reagent and upstream of the colorimetric test readout, a dwell region which transports therethrough a mixture of analyte from a sample and the color-producing reagent, the dwell region comprising a multiplicity of micro flow paths including hydrophobic flow impeding surfaces, the numbers and dimensions of the micropaths serving to set the incubation time within a predetermined time interval as the mixture passes therethrough. The dwell region may be, for example, impregnated with a hydrophobic material (e.g., wax) which impedes the rate of liquid passage through the dwell region. In some cases, the dwell region is manufactured by printing a hydrophobic material onto a surface of a sheet and heating to absorb the hydrophobic material into the pores of the sheet.

In some embodiments, the device may comprise an adsorptive reservoir downstream of the colorimetric test readout for drawing liquid along the flow path and through the dwell region and colorimetric test readout thereby to remove unbound colored species from the colorimetric test readout. A device may comprise in some instances an immobilized binder (e.g., an antibody) at the colorimetric test readout for capturing a complex formed during incubation in the dwell region. The device may include a sheet holding a dried, color-producing reagent in fluid communication with a parallel disposed sheet defining the dwell region. In certain embodiments, at least two of the following elements of the device are defined on a single said adsorptive sheet: a region holding a dried, color-producing reagent; a sample input; a colorimetric test readout; a dwell region; and an adsorptive reservoir.

In three-dimensional embodiments of the invention, the devices may comprise a patterned layer of adhesive which constitutes the barrier layer between adjacent adsorptive or absorptive sheets and which defines an opening permitting liquid flow communication between the sheets. This provides flexibility and control, as well as multiplexing of test paths on a single device. For example, the inlet and readout may be disposed on different sheets, or the readout and a the color-producing reagent(s) may be disposed on different sheets

The devices of the invention may further comprising a color chart relating color at the readout to analyte concentration, and this may optionally be integrated with a sheet. Of course, plural readouts serviced by respective different dried, color-producing reagents are enabled by the disclosure herein. Flow paths in the devices typically comprise one or a pattern of hydrophilic channels which direct transport of liquid flow and are defined by liquid impermeable boundaries substantially permeating the thickness of the hydrophilic sheet. The devices optionally may include an electrode assembly comprising one or more electrodes in liquid flow communication with the input region, and/or a thermally or electrically conductive material in communication with a flow path which can serve to control flow as a valve, or to evaporate fluid, for example. See, for example, International Patent Application Publication No. WO/2009/121041 and U.S. Ser. No. 13/254,967, the disclosures of which are incorporated herein by reference.

In still another aspect the invention provides methods of manufacturing test devices for determination of one or more analytes in liquid biological samples enabling mass production of reliable, extremely inexpensive test devices designed for quantitative or semi-quantitative clinical assays for any one or combination of analytes. The method comprises the steps of a) providing a first porous, hydrophilic sheet which supports absorptive or adsorptive flow transport; b) printing onto the sheet an array of test device elements respectively comprising a pattern of hydrophobic barriers permeating the thickness of the porous sheet to define respective elements, each of which comprise plural functional regions including a liquid flow path and a colorimetric test readout; c) adhering to the first sheet a second porous, hydrophilic sheet to form a laminate; and d) cutting the laminate to separate individual elements to form a multiplicity of functional test devices. In preferred embodiments, prior to step d) one or more reagents are applied on each of the test device elements, e.g., by robotically pipetting. The reagents may be deposited on the first or second porous, hydrophilic sheet, or onto a separate structure that serves as a reagent reservoir located to be contacted with liquid sample applied to the input. The first and second sheets are aligned prior to step c to register structural features so as to implement fluid flow communication between the sheets. Also, the method may include the additional steps of providing a third sheet or additional multiple sheets defining other structure, e.g. an array of filter elements, and laminating the third or additional sheets to the first and second sheets to position functional structure such as a filter element in fluid communication with respected liquid flow paths of respective test device elements. Step c often comprises the step of providing a liquid impermeable layer between the first and second sheets, which may itself act as an adhesive layer. This may be done by application of two-sided adhesive sheet material designed to isolate flow of liquid on respective sheets except for one or more defined holes positioned to permit liquid flow communication between the sheets. Preferably, the liquid impermeable layer is produced by applying an adhesive to a sheet in a pattern.

In another embodiment of the invention a method of manufacturing further comprises applying by printing onto a region of the surface of a sheet a predetermined density of ink, causing the ink to penetrate the sheet, and hardening the ink to form a dwell region comprising a multiplicity of micro flow paths including hydrophobic flow impeding surfaces defined by the ink, the numbers and dimensions of the micropaths serving to set a predetermined time interval for liquid sample to pass through the dwell region. The method may further comprise the additional step of applying by printing onto the surface of the sheet a higher density of the ink to define a border of a flow path, causing the ink to penetrate the sheet, and hardening the ink to produce a liquid impermeable barrier defining a liquid flow path in fluid communication with the dwell region. Also, the method may include the additional step of laminating the sheet to at least one additional porous, hydrophilic sheet which supports absorptive flow transport, at least a portion of which is in liquid communication with the sheet, and which additional sheet defines at least one element selected from the group consisting of a flow path; a colorimetric test readout; an immobilized binder at a test region for capturing a complex; a second dwell region; a liquid sample inlet; a control site; a dried, color-producing reagent reservoir, an adsorptive reservoir, and a sample split layer. A sample split layer allows a sample to be divided, for example, so that multiple assays can be run in parallel.

The method may include yet another additional step of applying by printing onto the surface of the sheet a higher density of the ink to define a border of at least one element selected from the group consisting of a flow path; a colorimetric test readout; an immobilized binder at a test region for capturing a complex; a second dwell region; a liquid sample inlet; a control site; a dried, color-producing reagent reservoir; an adsorptive reservoir; and a sample split layer in liquid communication with the sheet, causing the ink to penetrate the sheet, and hardening the ink to produce a liquid impermeable barrier defining a border of the element. In some embodiments, method may comprise providing a filter or a color-producing reagent reservoir in fluid flow communication with the dwell region. The method may include applying by printing onto plural regions of the surface of the sheet in an array a predetermined density of ink to produce an array of the dwell regions, laminating the sheet to at least one additional porous, hydrophilic sheet which supports absorptive flow transport, at least a portion of which is in liquid communication with the sheet, and which additional sheet defines a corresponding array of at least one element selected from the group consisting of a flow path; a colorimetric test readout; an immobilized binder at a test region for capturing a complex; a second dwell region; a liquid sample inlet; a control site; a dried color-producing reagent reservoir; an adsorptive reservoir; and a sample split layer.

### DESCRIPTION OF THE DRAWINGS

The invention is herein described, by way of example only, with reference to the accompanying drawings, wherein dimensions are not to scale, but rather are selected as a means of describing the structure and operation of the various devices discussed. Further, this patent or application file contains at least one drawing executed in color. Copies of this patent or patent application publication with color drawing(s) will be provided by the Office upon request and payment of the necessary fee.

FIG. 1 shows an exploded perspective view of a device comprising a plurality of parallel-disposed sheets (panel a), schematic diagram illustrating a method for performing an assay using the device (panel b), and read guides for quantifying the results of the assay (panel c), according to an embodiment;

FIG. 2 shows a liver enzyme test device that includes two tests and three controls and exemplary result outputs, according to an embodiment;

FIG. 3 shows a control region of a device that undergoes a color change from white to yellow when wet, according to an embodiment;

FIG. 4 shows a comparison of color readout on a white background (top panel) and a yellow background (bottom panel) illustrating improved contrast with the yellow background;

FIG. 5 shows exemplary useful AST assay chemistry (FIG. 5A) and exemplary ALT assay chemistry (FIG. 5B);

FIG. 6 illustrates designs for multiplexed devices, according to various embodiments;

FIG. 7 is a diagram useful in illustrating a method of manufacturing a plurality of devices, according to an embodiment;

FIG. 8 illustrates a device incorporating a timing element, according to an embodiment;

FIG. 9 illustrates a plasma separation membrane filter attachment process in a device fabrication method, according to an embodiment;

FIG. 10 shows an exploded view of a device configured for quantitative colorimetric readout (left panel) and exemplary assay readouts (right panel), according to an embodiment;

FIG. 11 shows a device configured for quantitative colorimetric readout; more filled circles means higher concentration of analyte;

FIG. 12 is a plan and perspective view of a device for quantitative colorimetric readout that includes a color chart for automated calibration;

FIGS. 13A and 13B are bottom and top views of a liver enzyme test device embodying the invention;

FIG. 14 shows a device displaying a gradation of color from yellow to red for an ALT assay as a function of increasing ALT concentration and a gradation of color from dark blue to pink in an AST assay as a function of increasing AST concentration;

FIG. 15 shows a calibration plot of the output signal of the liver function test (LFT) versus the concentration of AST (left panel) or ALT (right panel) (N=7 for each concentration), according to an embodiment; and

FIG. 16 shows standard curves generated for the ALT test as a function of ALT concentration (left panel) and the AST test as a function of AST concentration (right panel), according to an embodiment.

### DETAILED DESCRIPTION

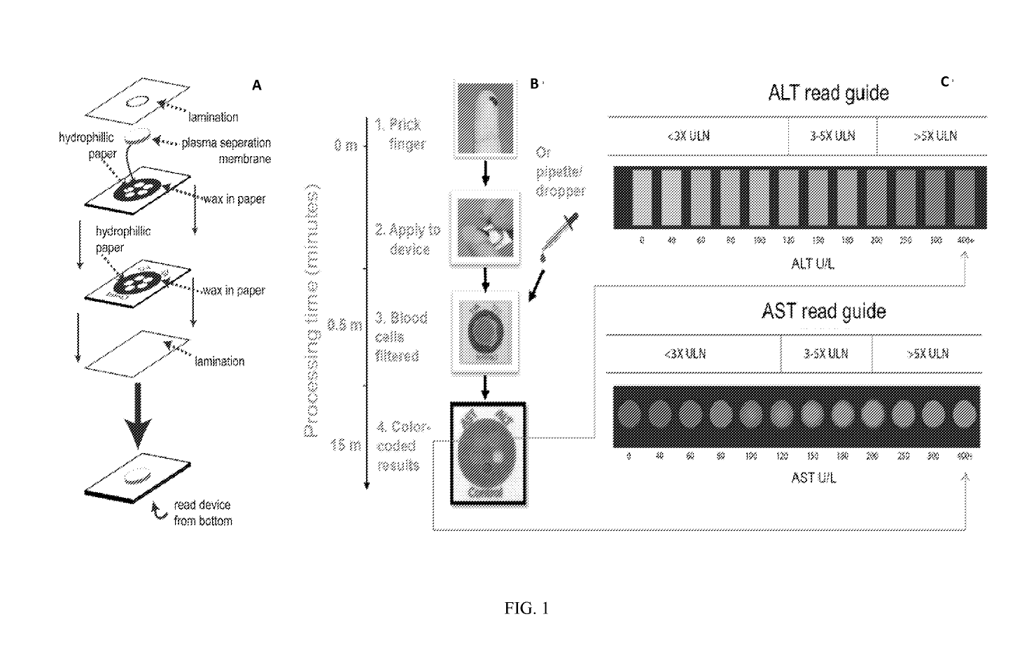

Referring now to FIG. 1, a non-limiting exploded view of an aspartate aminotransferase (AST)/alanine aminotransferase (ALT) test device and an exemplary assay protocol are shown. A test device may comprise a plurality of sheets (i.e., layers) disposed parallel to one another (e.g., to form a stacked configuration), as shown in panel A of FIG. 1. The device may include a plurality of porous, hydrophilic sheets, which may be disposed between hydrophobic sheets, such as a top laminate and a bottom laminate. The top-laminate includes a sample inlet defined by an opening in the top-laminate. The device may further include a filter (e.g., a plasma separation membrane) that, in some embodiments, may be positioned between the top laminate and a porous, hydrophilic sheet. As shown in FIG. 1, the porous, hydrophilic sheets may be patterned with a hydrophobic barrier (e.g., wax) to form one or more functional regions (e.g., a sample input, a test readout, a positive control, a negative control, a flow path, and the like). In the exemplary test device shown in panel A, functional regions define two test regions and three control regions. One or more reagents may be deposited on one or both of the porous, hydrophilic sheets. The layers may be affixed to each other using, for example, an adhesive and/or by laminating the stacked layers.

Referring now to panel B of FIG. 1, a drop of biological fluid (e.g., blood) may be applied to the sample inlet of the test device. Cells in the biological fluid (e.g., erythrocytes and leukocytes) are separated by the filter in the device and the resultant plasma wicks through the functional regions. After a period of time (e.g., about 15 minutes) the test regions are compared to a corresponding color guide (FIG. 1, panel C) to quantify the results of the assay. In some embodiments, the results may be interpreted as being within range of values, e.g., less than about three times (<3×) the upper limit of normal (ULN, defined in this example as 40 U/L), between about three and about five times (3-5×) the upper limit of normal, or greater than five times (>5×) the upper limit of normal.

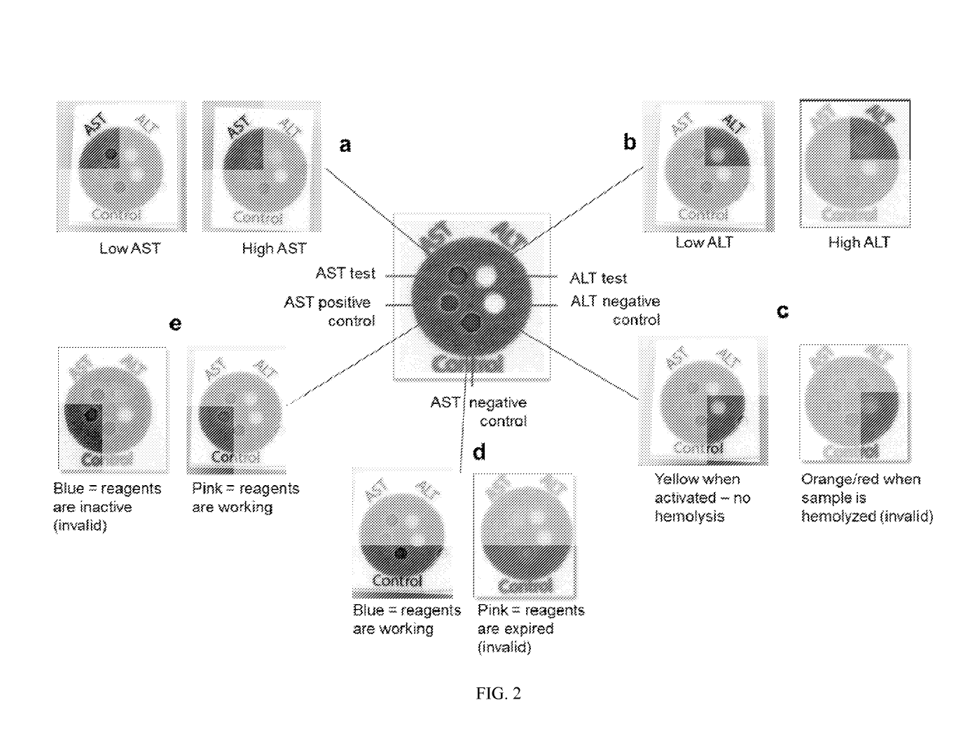

FIG. 2 further illustrates the use of a liver function test device and provides various readout possibilities. A schematic of test and control regions is shown in the center of the figure. In this exemplary device, an AST test, an AST positive control, an AST negative control, an ALT test, and an ALT negative control are provided. As shown in panel A, in the AST test region, normal AST values (e.g., <80 units/Liter (U/L)) result in a dark blue color (“Low AST”), whereas high AST values (e.g., >200 U/L) result in a bright pink color (“High AST”). In the ALT test region (as shown in panel B), normal ALT values (e.g., <60 units/Liter (U/L)) result in a yellow color (“Low ALT”), whereas high ALT values (e.g., >200 U/L) result in a deep red color (“High ALT”). Panels C, D, and E illustrate the operation of control regions in the test device. In the ALT negative control region (panel C), a change from white to yellow occurs upon wetting of the region, indicating appropriate device activation and essentially no hemolysis (“Yellow when activated—no hemolysis”), where as in the event of sample hemolysis, the region becomes orange/red and the device is read as “invalid” (“Orange/red when sample in hemolyzed (invalid)”). In the AST negative control region (panel D), the baseline blue color remains unchanged if dye chemistry is functioning properly (“Blue=reagents are working”), whereas the control region becomes bright pink in the event of non-specific dye reaction (“Pink=reagents are expired (invalid)”) and the device is read as “invalid.” In the AST positive control region (panel E), the region changes from blue to pink if AST reagents are functioning properly (“Blue=reagents are inactive (invalid)”), but remains dark blue if either the reagents are not functioning or the zone is not activated (“Pink=reagents are working”), and the device is read as “invalid.”

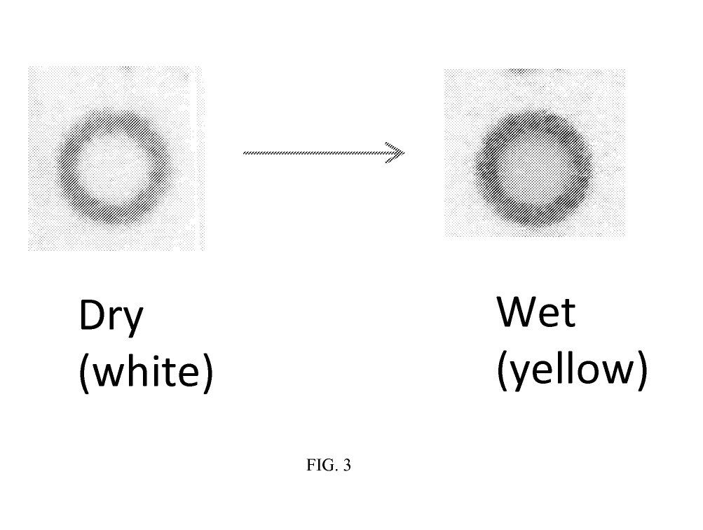

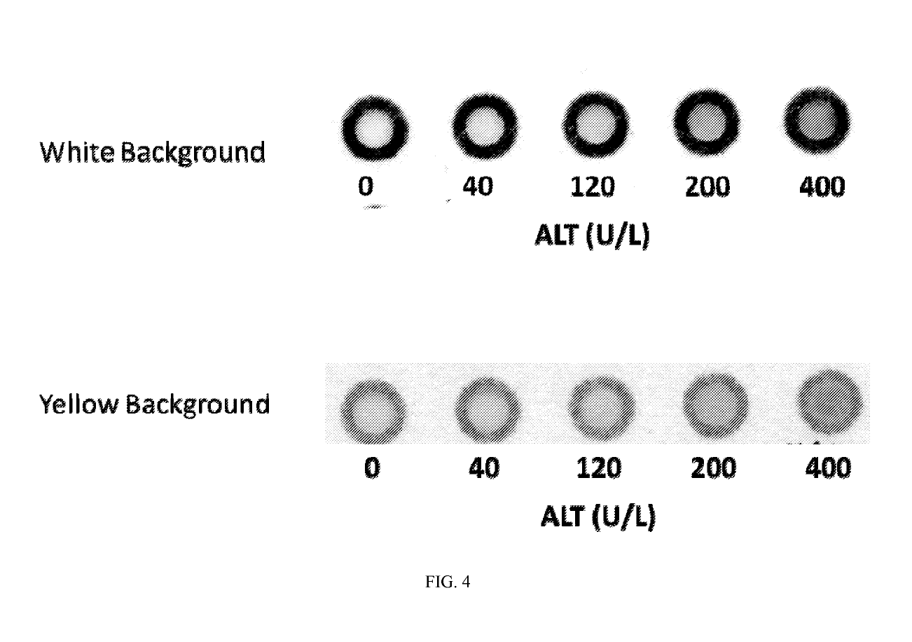

As shown in FIG. 2, panel C, a control region can change color upon wetting, for example, to indicate device activation. In some embodiments, this effect may be achieved using a pigment on a layer of the test device. For example, the pigment may not be visible from the side opposite of the side on which the pigment is printed when the device is in a dry state. Without wishing to be bound by any theory, it is believed that the pigment is essentially not visible when the device is in the dry state due to the scattering of light by the fibers (e.g., cellulose) in the porous, hydrophilic sheet and the difference in refractive index between the fibers and the air. Upon introduction of fluid into the porous, hydrophilic sheet, the refractive index difference is reduced and the porous, hydrophilic sheet becomes semi-transparent, thus revealing the colored pigment on the reverse side. This simple effect is further illustrated in FIG. 3 and can serve two important functions. Firstly, observation of color change from white to a color other than white, e.g., yellow or another background color, can indicate to the user that a sufficient volume of fluid sample has been applied to the device and wicked to the appropriate region. Secondly, the color may serve as a background color to add contrast to a given colorimetric reaction. An example of the color adding contrast is shown in FIG. 4, where an ALT assay which results in the production of a red/purple-colored dye progresses through shades of red/purple with increasing ALT concentration when performed on a white background (top panel), whereas this same reaction progresses from yellow to orange to red when performed against a yellow background (bottom panel) thus resulting in different colors with changing concentration as opposed to varying shades of the same color with changing concentration. Advantageously, this effect can greatly aid in the ability of a user to interpret colorimetric data. Also advantageously, the color can reverse back to white when the functional region is dry, thereby indicating to a user that a device is past the window for when it can be read and valid results obtained.

In some embodiments, it is particularly useful to have two or more layers of patterned paper in the device. For instance, with two or more layers, separation of reagents that would otherwise react quickly when mixed may be achieved. For example, in the device positive controls, a first layer of paper may contain dried enzyme (e.g., AST or ALT) and the second layer may contain reagents (e.g., substrates) that react with the enzyme. This configuration may operate as follows. A sample may be added into the device, and fluid from the sample wicks into the first layer, releasing the dried enzyme, and then to the second layer where the enzymes can mix with the reagents (e.g., reactive chemistry). By contrast, in some cases, if the enzyme was deposited on the same layer as the reactive chemistry, it could react prematurely leading to undesired results. Separation of reagents into different layers also can allow for separate formulation chemistry to be used to stabilize specific reagents. For example, an enzyme could be stabilized with a sugar in one layer, and a dye molecule stabilized with a water-soluble polymer in another layer. In addition, multi-layer devices can help prevent migration of dyes or other reagents, which is often seen when flow occurs only in a lateral direction.

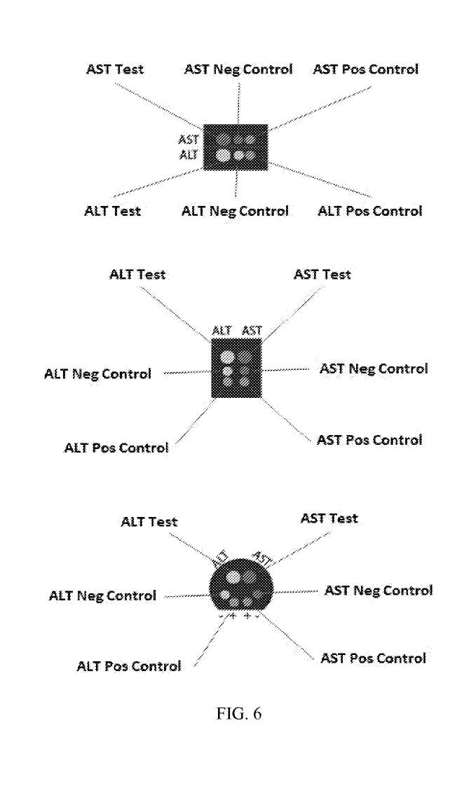

In a preferred embodiment, the liver transaminase test may contain six test zones. This design provides a test zone for ALT with separate positive and negative controls and a test zone for AST with separate positive and negative controls. Various designs and layouts can be considered for the zones. FIG. 6 illustrates some non-limiting potential designs for six zone tests.

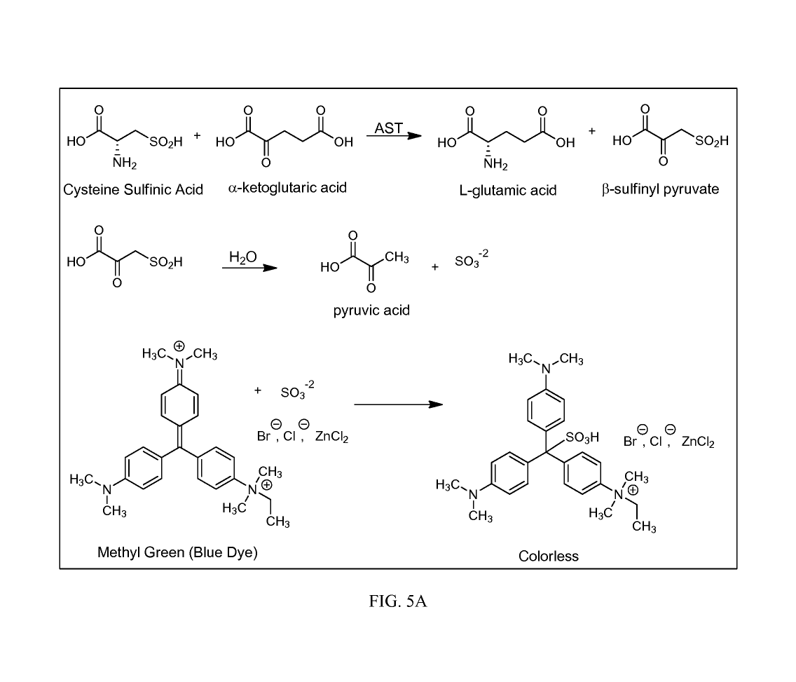

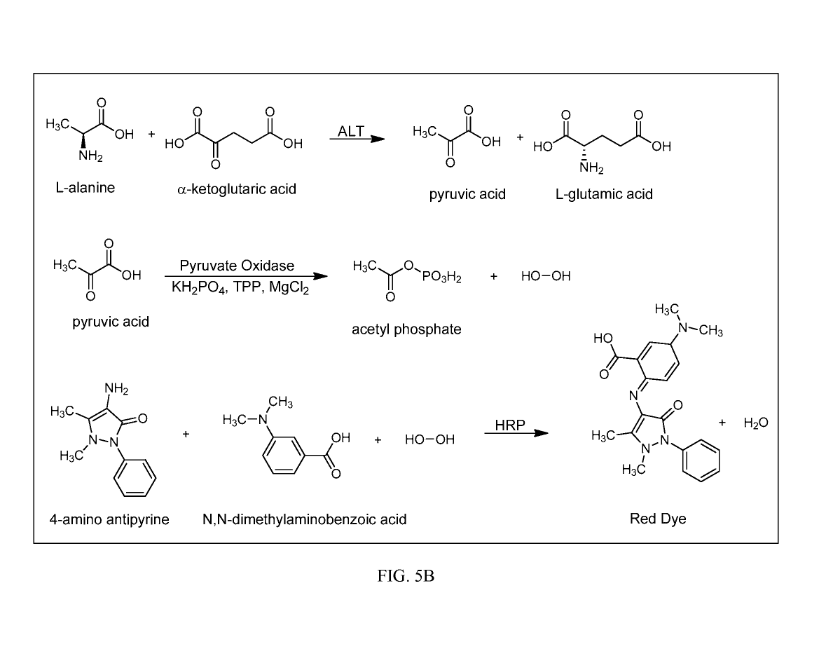

A particularly useful chemistry of the present embodiment for the measurement of AST and ALT in a blood sample is illustrated in FIG. 5. The AST assay chemistry utilizes AST present in a sample to convert cysteine sulfinic acid and alpha-ketoglutaric acid to L-glutamic acid and beta-sulfinyl pyruvate. The beta-sulfinyl pyruvate reacts with water to yield free SO₃⁻² which further reacts with methyl green, a blue-colored dye, to yield a colorless compound. This reaction is performed against a pink contrast dye, created by also spotting Rhodamine B onto the paper. As the reaction proceeds, and the dye becomes converted to a transparent compound, more of the pink background is revealed. The visual result is that the detection zone changes from a dark blue to a bright pink color in the presence of AST.

Yet another useful chemistry of the present embodiment for the measurement of AST in a blood sample employs (oxaloacetate decarboxylase). AST present in a sample converts L-aspartic acid to oxaloacetate. Oxaloacetate reacts with oxaloacetate decarboxylase to generate pyruvate which is subsequently oxidized by pyruvate oxidase to form acetyl phosphate and hydrogen peroxide, and the liberated hydrogen peroxide is used by horseradish peroxidase to generate a red-colored dye 4-N-(1-imino-3-carboxy-5-N,N dimethylamino-1,2-cyclohexanediene) through the coupling of 4-amino antipyrine and N,N-dimethylaminobenzoic acid.

The ALT assay chemistry is based on the conversion by ALT of L-alanine and alpha-ketoglutaric acid to pyruvic acid and L-glutamic acid, the subsequent oxidation of pyruvic acid by pyruvate oxidase to form acetyl phosphate and hydrogen peroxide, and the utilization of the liberated hydrogen peroxide by horseradish peroxidase (HRP) to generate a red-colored dye 4-N-(1-imino-3-carboxy-5-N,N dimethylamino-1,2-cyclohexanediene) through the coupling of 4-amino antipyrine and N,N-dimethylaminobenzoic acid. In further embodiments, the pyruvate generated in the AST chemistry could be used in the same reaction cascade as in the ALT assay as described in U.S. Pat. No. 5,508,173.

Huang et al. describe several methods for transaminase detection in Sensors 2006; 6(7):756-782, which is hereby incorporated by reference in entirety. Additionally, Anon et al. describe methods for AST and ALT detection in Scand. J. Clin. Lab. Invest. 1974; 33(4):291-306, which is hereby incorporated by reference in entirety.

In further embodiments, it is envisioned that additional zones could be added to the test device to accommodate more assays. In a notional embodiment of the present invention, the test contains detection zones for ALT, AST, bilirubin, ALP, GGT, and albumin along with positive and negative controls for some or all of the tests. In still further embodiments, the AST and ALT assays may be multi-plexed with other assays such as creatinine for monitor of kidney function or even immunoassays such as those used to detect hepatitis.

While various aspects of the test device have been exemplified in the context of liver function tests, it should be understood that the test device is not limited to liver function tests. Any suitable biological assay may be performed using the test device described herein. For example, the biological assay may be used to quantify a component of a biological fluid, such as a protein, nucleic acid, carbohydrate, peptide, hormone, small molecule, virus, cell, microorganism, and the like. The biological assay may also be used to quantify an activity (e.g., blood clotting, ALT, AST, amylase, creatine kinase, etc.) in a biological fluid.

In some embodiments, the multiple layers of a test device may be held together by an adhesive. Any suitable adhesive may be used. For example, in some instances, a hydrophobic, polymeric, adhesive may be used. In further embodiments, the adhesive may be patterned by a printing technique including, but not limited to, screen printing, flexographic printing, gravure printing, transfer printing, and ink-jet printing. A preferred embodiment is to pattern the adhesive by screen printing. Whitesides et al. report a method for adhering multiple layers of patterned paper together using double-sided tape cut with a laser cutter (Proc Natl Acad Sci 105:19606-19611, which is incorporated herein by reference in entirety). When the cut double-sided tape is used, it leaves a gap caused by the thickness of the tape and prevents contact between the hydrophilic regions of the patterned paper. This gap must be filled with cellulose powder to enable z-direction flow (i.e., tangential flow through the device). Screen printing of adhesives offers several advantages over this technique. For example, the patterned adhesive layer typically can be applied in very small thicknesses (e.g., between about 1 and about 500 microns, between about 1 and about 100 microns, between about 1 and about 50 microns, and between about 50 and 100 microns), which allows for intimate contact to occur between the hydrophilic regions of the patterned paper and eliminates the need to use the cellulose powder filler. Screen printing may also require much less material than double-sided tape, which reduces device raw material cost. Furthermore, screen-printing is a low-cost and easily scaled patterning technique, which is advantageous for inexpensive, mass production of the test devices. In the specific embodiment of the paper Liver Transaminase test, the printed adhesive holds the paper in contact as well as ensures contact to the plasma separation filter through adhesion. In a preferred embodiment, the adhesive may be a pressure sensitive adhesive. In further preferred embodiments, the adhesive is Unitak 131 sold by Henkel Corporation.

The manufacturing unit operations for a test device can be separated into a series of steps. For example, in some embodiments, the manufacturing operations may include some or all of the following steps: patterning of the paper substrate with hydrophobic barriers, patterning of adhesive by screen printing, deposition of biological/chemical reagents, layer alignment and assembly, attachment of plasma separation membrane, and/or lamination and packaging.

A preferred method for patterning paper to be used in a test device is wax printing, although any suitable method for creating hydrophobic barriers on a porous, hydrophilic sheet may be used. Wax printing is described in detail by Whitesides et al. in Anal Chem 81:7091-7095 and International Patent Application Publication No. WO 2010/102294, both of which are hereby incorporated by reference in entirety. The device may be designed on a computer and the hydrophobic walls of the microfluidic channels may be printed onto a sheet of paper using a commercial printer with solid-ink technology (e.g., using a Xerox Phaser printer). The printer generally operates by melting the wax-based solid ink and depositing the ink on top of the paper. The sheet is then heated to above the melting point of the wax, allowing wax to permeate through the thickness of the paper, thereby creating a hydrophobic barrier through the entire thickness of the paper. In some cases, spreading of the wax may occur during the heating step, but the spreading is reproducible based on the type of paper used and the thickness of the printed line and can be incorporated into the design. Without wishing to be bound by any theory, it is believed that the channels patterned in the paper wick microliter volumes of fluids by capillary action and distribute the fluids into test zones where independent assays can take place.

Other method embodiments may use paper soaked in photoresist which is then exposed to UV light through a photomask with a desired pattern. The unexposed regions are then washed away with a suitable solvent, leaving behind crosslinked hydrophobic regions that penetrate the thickness of the paper. Feature sizes as small as 100 μm have been demonstrated using this technique. Examples of this method of patterning can be found in prior work from in Angew. Chem. Int. Ed. 2007, 46, 1318-1320 and International Patent Application Publication No. WO 2008/049083, which is hereby incorporated by reference in entirety. In further embodiments, there is a host of other large-scale printing and patterning techniques that can be used to deposit hydrophobic barriers into paper to meet the requirements of the test device. These methods include, but are not limited to: screen-printing, gravure printing, contact printing, flexographic printing, hot embossing, ink jet printing, and batik printing.

In several embodiments of the present invention, the layers may be adhered together in such a way that fluids can wick in the z-direction (i.e., tangentially) to entry points in the next layer of paper. One method of accomplishing this is by using double-sided adhesive tape with holes cut into the desired pattern through which fluid can flow. This method is described in more detail in Proc. Natl. Acad. Sci. USA, 2008, 105, 19606, which is hereby incorporated by reference in entirety. In this particular method, a hydrophilic powder (i.e., cellulose) may be added in the cut aperture between the layers of paper formed by the thickness of the tape. A preferred method for assembly of 3-D devices is to use simple and scalable screen-printing techniques to deposit very thin layers of adhesive onto paper in the desired pattern. In this manner, a hydrophobic, pressure-sensitive adhesive (e.g., Unitak 131 sold by Henkel Corporation) can be applied to the paper. Once adhesive is applied, pre-made sheets can be stored by laminating the adhesive side to a non-adhesive release layer, for example as commonly seen in other adhesive products such as labels and tapes. In further embodiments, a stencil can be fabricated and pressed against a sheet of patterned paper in such a way that certain features are covered. An adhesive may then be deposited from an aerosol spray onto the remaining exposed regions.

In preferred embodiments, it is necessary to deposit chemical and/or biological assay reagents into regions of the device. The reagents react with analytes present in a bodily fluid and which yields a response (i.e., colorimetric or electrochemical) that can indicate the concentration of a particular analyte. In some embodiments, it is often necessary to formulate reagents with appropriate stabilizers (e.g., sugars) to preserve function once dried. In one embodiment, useful for prototyping and small scale production (e.g., 100's of devices per day), deposition of reagents is done by hand using micropipettes and repeat pipetters. A typical volume deposited is between 0.5 and 5 μL. In preferred embodiments for larger scale production, precision liquid deposition machines can be used. Two examples of such tools are the AD3400 available from BioDot, Inc. and the Diamatix DMP-2800 Ink Jet printer available from Fujifilm. Both of these units are able to rapidly dispense precise volumes (contact-free) of fluid down to nL volumes in a programmed pattern. Additionally, such units can be adapted to continuous manufacturing lines for large scale production.

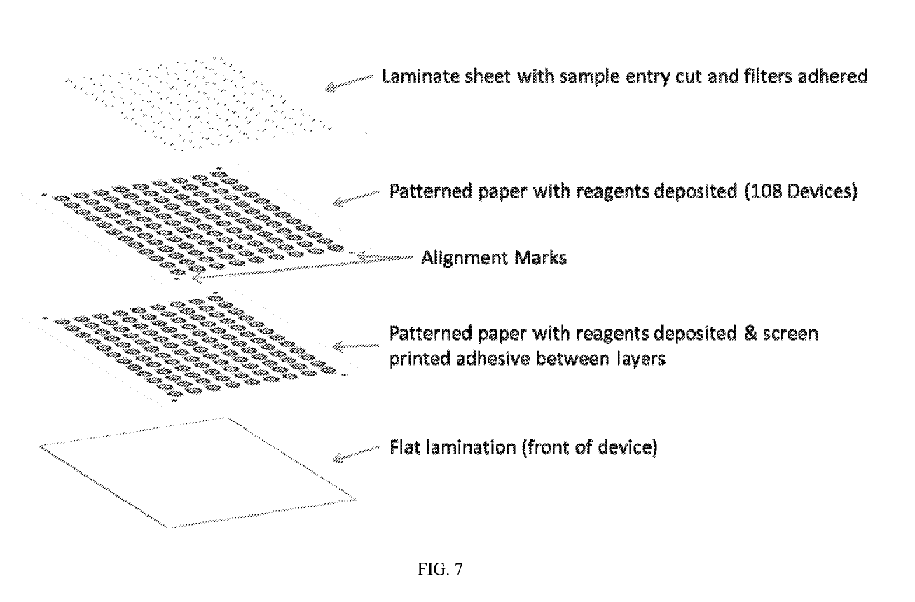

In preferred methods of manufacture, devices are assembled in full sheets, for example, as shown in FIG. 7. For this to occur, it is imperative that patterned regions precisely align to make the necessary fluidic junctions possible between layers. A simple and scalable way to accomplish this is to cut precise holes in the paper layers such that the sheets can slide onto peg boards. Each layer can then be applied to the peg board such that features are rapidly aligned correctly. The adhesive applied earlier acts to lock the sheets in place once in contact. In continuous manufacturing, a similar method can be used on reels containing pegs such as that used in Dot-Matrix Printing. Alternatively, laser web guides can be used to precisely align sheets before lamination. Other methods for aligning the sheets will be known to those of ordinary skill in the art.

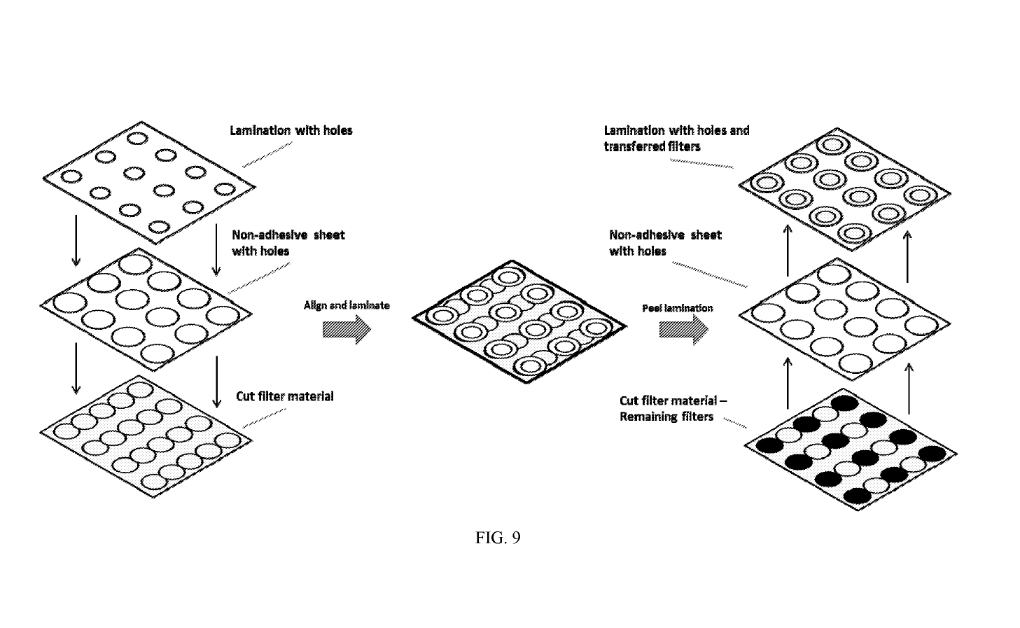

As seen in FIG. 1, a plasma separation membrane (Pall Corporation) may be placed at the entry point of the device. The membrane may serve as a reservoir to collect a biological fluid (e.g., a blood drop) and importantly to filter cells (e.g., red blood cells) out of the biological fluid and allow fluid (e.g., plasma) to wick into the device zones. Accordingly, embodiments of the present invention utilize a “pick and place” method consisting of the following steps (illustrated in FIG. 9):

(i) A sheet of Pall membrane may be cut into densely packed circles 1 cm in diameter using a laser cutter or die cutter. The cut sheet may be laminated to a surface with low adhesion such as a low-tack laminate sheet or a rubbery sheet. In preferred embodiments, the cut membrane sheet is adhered to a PET film coated with PDMS.

(ii) A sheet of adhesive laminate may be cut using a knife plotter, laser cutter, die cutter, or the like such that it contains apertures which act as an entry point into the filter/device (top layer of FIG. 7). The holes in the laminate sheet may be between about 0.1 cm and about 1.5 cm in diameter or between about 0.5 cm and 1.0 cm. In a preferred embodiment, the holes are about 0.75 cm in diameter.

(iii) A non-adhesive masking layer may be cut, e.g., from waxy cardstock, or other materials with low adhesion, in a pattern to have holes that are larger than the filters. For example, in some embodiments, the diameter of the holes in the non-adhesive masking layer may be more than about 0.2 cm, more than about 0.3 cm, more than about 0.4 cm, or more than about 0.5 cm larger than the diameter of the holes in the membrane. In a preferred embodiment, the holes in the masking layer are about 1.13 cm in diameter.

(iv) The previously cut laminate containing 0.75 cm holes and the masking layer may be adhered together such that the laminate aperture is in the middle of the blocking layer aperture.

(v) The stack may be placed over the densely cut membrane sheet in such a way as to only pick up filter membrane discs that align with the cut laminate sheet. The others membrane discs are blocked by the masking layer.

(vi) The stack may be then laminated and the adhesive laminate layer peeled away which, as it is peeled, adheres a filter over each laminate aperture on the laminate sheet while leaving the others behind for the next set of devices.

(vii) The laminate layer, now with a filter membrane adhered under each aperture, may be adhered to a stack of two layers of patterned paper which may be adhered together by screen printed adhesive.

In this way, the maximum area of the membrane material can be converted into useable filtration discs for devices. Using die-cutting techniques and simple laminators, this process can be easily automated into large scale-production.

An alternative method accomplishes the cutting and placement of the filter membrane using a die cutting method described below:

(i) A sheet of Pall membrane may be cut into densely packed circles 1 cm in diameter using a die cutter. The die used for cutting is designed such that the filters remain in place after cutting. This is accomplished through the presence of a rubber plug embedded within each feature.

(ii) A sheet of adhesive laminate may be cut using a knife plotter, laser cutter, die cutter, or the like such that it contains apertures which act as an entry point into the filter/device. The holes in the laminate sheet may be between about 0.1 cm and about 1.5 cm in diameter or between about 0.5 cm and 1.0 cm. In a preferred embodiment, the holes are about 0.75 cm in diameter.

(iii) A non-adhesive masking layer may be cut, e.g., from waxy cardstock, or other materials with low adhesion, in a pattern to have holes that are larger than the filters. For example, in some embodiments, the diameter of the holes in the non-adhesive masking layer may be more than about 0.2 cm, more than about 0.3 cm, more than about 0.4 cm, or more than about 0.5 cm larger than the diameter of the holes in the membrane. In a preferred embodiment, the holes in the masking layer are about 1.13 cm in diameter.

(iv) The previously cut laminate containing 0.75 cm holes and the masking layer may be adhered together such that the laminate aperture is in the middle of the blocking layer aperture.

(v) the stack may be placed over the previously cut filter discs (in registration on the die plate) in such a way as to only pick up filter membrane discs that align with the cut laminate sheet.

(vi) The adhesive laminate layer is peeled away which, as it is peeled, adheres a filter over each laminate aperture on the laminate.

(vii) The laminate layer, now with a filter membrane adhered under each aperture, may be adhered to a stack of two layers of patterned paper which may be adhered together by screen printed adhesive. In this way, the maximum area of the membrane material can be converted into useable filtration discs for devices. Using die-cutting techniques and simple laminators, this process can be easily automated into large scale-production.

After the steps above have taken place, the stack of patterned paper (and filters, etc, if required) may be laminated. In some embodiments, a “cold lamination” sheet consisting of a PET film with adhesive on one side may be used. The film protects the devices and provides the outer hydrophobic layer for the patterned zones. The device elements may then be separated into separate devices (e.g., cut into separate devices). In some embodiments, the devices may be placed in foil-lined bags and heat sealed, preferably where the bags contain a desiccant.

In some embodiments of the present invention, it is useful to have certain sample handling features built into the device itself. For example, one such feature is a simple plastic cover that protects the sample entry aperture. After a drop of biological fluid is introduced to the device via the entry aperture and into the filter membrane, a plastic cover may then seal the aperture to slow the evaporation and drying of the fluids in the device.

In further notional embodiments, it may be desired to have a built-in capillary capable of drawing a precise volume of blood into the device by simply making contact with the droplet. Such a feature can minimize user operations and ensures reproducibility in the volume of sample introduced to the device.

In still further notional embodiments, a test device may contain a built-in lancet, which is disposed of along with the device after use.

In some embodiments, the device may be used as part of a kit containing a glass or plastic capillary tube, in preferred embodiments the tube is plastic, such as the MicroSafte Tube available from Safe-Tec®. In some embodiments, the kit may contain a lancet, in preferred embodiments, the lancet is a spring-loaded lancet, such as those available from Surgilance™. In still further embodiments, a kit will contain patterned paper devices, a lancet, a capillary tube, a bandage, an alcohol swab, latex gloves, and a colorimetric read guide for interpretation of results.

As discussed above, in some embodiments, a filter may be incorporated into the device that serves to filter out blood cells (as well as dirt, fibers, etc.) for the isolation of plasma, which then wicks into the device. In preferred embodiments, the filter is a Vivd™ membrane available from Pall corporation. In other embodiments, the membrane can be a glass fiber membrane, or even a paper filter. In other embodiments, anti-blood cell antibodies may be attached to the membrane to facilitate capture of cells. In further embodiments, “scrubbing agents” may be added to the filter membrane or paper channels that are capable of capturing substances that may interfere with the reaction chemistry.

Nearly any porous material can be patterned by the methods disclosed. Accordingly, many materials can be patterned to generate a liver function test according to the present invention. Materials include, but are not limited to: paper, chromatography paper, nitrocellulose, non-woven polymeric materials, lab wipes, nylon membranes such as Immunodyne® membranes sold by Pall® corporation. A preferred material for the present invention is Whatman® no 1. chromatography paper.

In some embodiments of the present invention, stabilizers may be added to the reagent zones to further stabilize the enzymes spotted onto the paper. In further embodiments the stabilizers include but are not limited to: Trehalose, Poly(ethylene glycol), Poly(vinyl alcohol), Poly(vinyl pyrrolidone), Gelatin, Dextran, Mannose, Sucrose, Glucose, Albumin, Poly(ethylene imine), Silk, and Arabinogalactan. In some embodiments, dye stabilizers, such as MgCl₂ or ZnCl₂, may be added to the assays.

In preferred embodiments, the stabilizers are sugars. A particularly useful method for stabilizing enzymes and other proteins, vacuum foam drying, is described by Bronshtein et al. in U.S. Pat. No. 6,509,146, which is incorporated herein by reference in entirety.

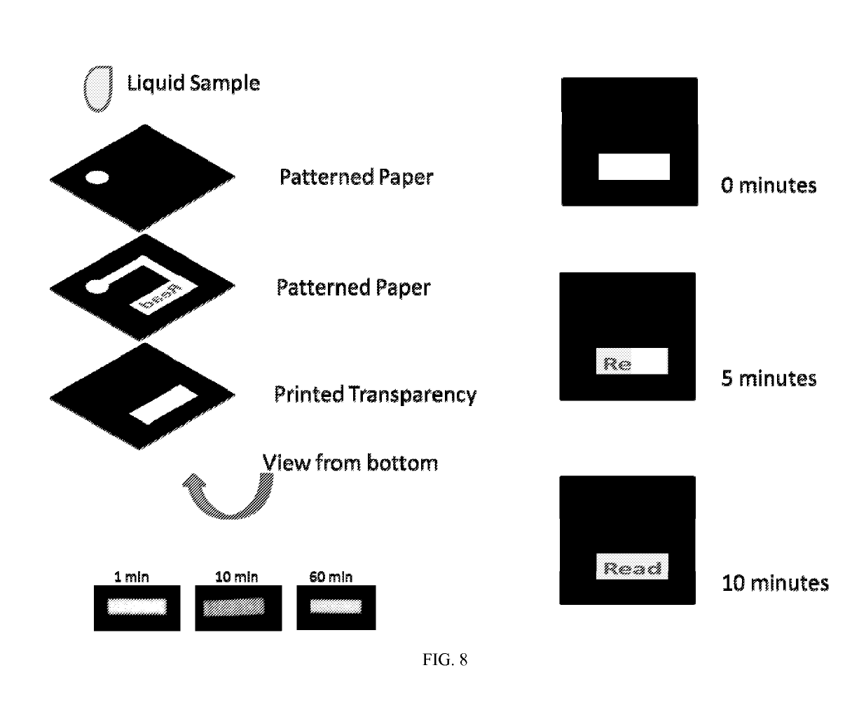

In some embodiments, a timer may be incorporated into the device which serves to indicate to an operator when the device should be read. Such timers have been described by Phillips et al. in Anal. Chem, 2010, 82, 8071-8078, which is incorporated herein by reference in its entirety. In further embodiments, a timer takes the form of a multi-layer device containing a channel of defined length and width such that fluid takes a predictable amount of time to travel to the end of the channel. Upon addition of sample to the device, fluid immediately begins to wick down the defined paper channels. As the fluid wets the channel, it can reveal printed messages on the reverse side of the paper as the paper becomes wet, and therefore transparent. This concept is illustrated in FIG. 8. In some embodiments, a timer of this type could be incorporated in a test device by incorporating a split layer after the entry where the fluid then travels to both the test zone and the timer channel simultaneously.

In certain embodiments, the positive control can act as a timer for the test in that when the positive control is fully developed, the device can be read. In further embodiments, the assay may be sensitive to heat or humidity leading to an acceleration or deceleration of the assay. In this situation, a positive control can be tailored such that it exhibits the same acceleration or deceleration effect. In this way, the device may be still read when the positive control is developed.

In some embodiments, the device may contain a dwell region which serves to provide a pre-determined incubation time for a solution at a particular point in the device. For example, it may be useful for an antibody conjugate and an antigen present in the sample to incubate before coming in contact with a capture antibody. The dwell region may take the form of a patterned zone where the hydrophilic, porous zone contains a hydrophobic material designed to slow the wicking rate of a fluid. In a preferred embodiment, the hydrophobic material is wax. The wax can be printed onto the dwell region using the same printer that is used to create the hydrophobic barriers (e.g., a Xerox Phaser 8560). In some instances, the barriers may be printed using a black color in a graphic design program. Varying amounts of wax can be printed into the dwell region by using the grayscale feature available, for example, in computer illustration programs, such as Adobe® Illustrator. In some embodiments, the printer generates a gray color by simply printing varying percentages of black wax ink against the white paper background. Thus, by simply selecting a particular shade of gray which can range, for example, from about 1% to about 99% black, one can control the amount of wax that is deposited into a particular zone. In this way, the time it takes for fluid to pass through the dwell region can be varied by increasing the intensity of the grayscale in the dwell region. Delay times can vary from a few seconds to hours. For example, the delay time may be between about 1 second and about 5 seconds, between about 2 seconds and about 10 seconds, between about 5 seconds and about 15 seconds, between about 10 seconds and about 30 seconds, between about 15 seconds and about 1 minute, between about 30 seconds and about 2 minutes, between about 1 minute and about 5 minutes, between about 2 minutes and about 10 minutes, between about 5 minutes and about 20 minutes, between about 10 minutes and about 30 minutes, between about 20 minutes and about 1 hour, between about 30 minutes and about 2 hours, between about 1 hour and about 3 hours, between about 2 hours and about 4 hours, and the like.

In still further embodiments, the dwell region can be fabricated by depositing solutions containing varying amounts of hydrophobic materials. In preferred embodiments these solutions contain polymers such as polystyrene or waxes such as paraffin. In some embodiments, the solution may contain between about 0.001% and about 0.01% hydrophobic material, between about 0.01% and about 0.1% hydrophobic material, between about 0.1% and about 1% hydrophobic material, between about 1% and about 10% hydrophobic material, between about 10% and about 50% hydrophobic material, or between about 50% and about 100% hydrophobic material. Any suitable solvent can be used to form the solution.

In still further embodiments, the dwell region can take the form of a channel of defined length. The length of the channel may be proportional to the time it takes for a fluid to travel the distance of the channel. Thus, for example, a fluid sample containing antigen that is introduced to a device and mixed with a conjugate antibody may have an incubation time corresponding to the length of the channel. Upon reaching the end of this channel, the fluid may travel vertically to a capture zone to form a full immune complex. In some embodiments, it may be useful for this channel to also contain hydrophobic materials to slow the wicking speed even more. These materials can be deposited in the same manner as described above using a wax printer or solution. In further embodiments, the channel's width may influence the dwell time. For example, a channel may start wide, then narrow for a portion and then widen, resulting in a lower flow rate at the narrow portion of the channel as compared to the wide portion of the channel. In some embodiments, the channel's flow path may influence the dwell time. For example, the channel may have a serpentine flow path, where, for example, the number of turns and/or the length of the turns of the flow path can be adjusted to control the dwell time.

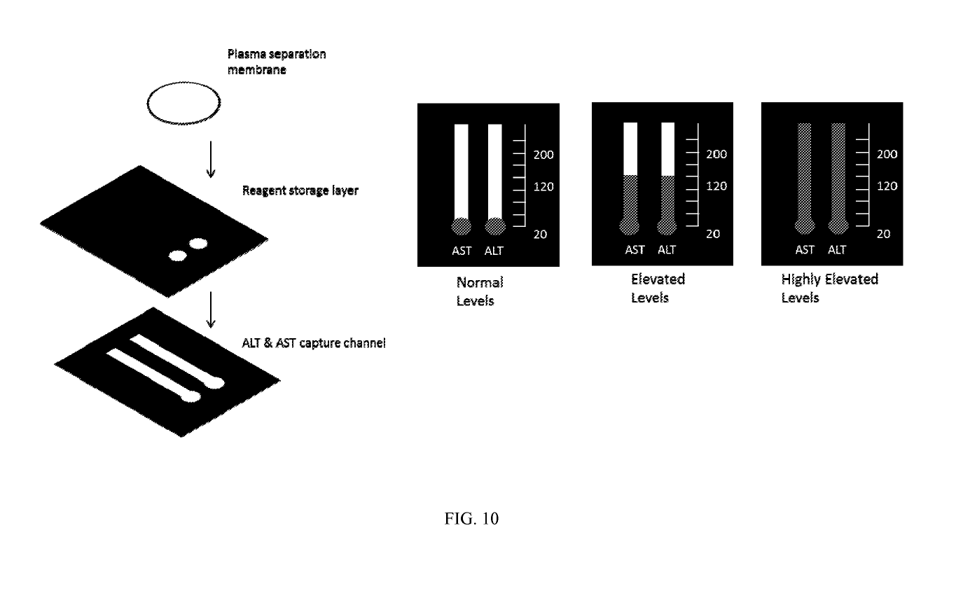

In a notional embodiment of the present invention, a multi-layer device formed from patterned paper is shown in FIG. 10. This particular design allows for a quantitative colorimetric readout. The device comprises a plasma separation membrane adhered to one or more layers of patterned paper comprising regions (i.e., zones) used to store reagents which are formulated to release upon contact with fluid sample. The ALT zone may contain L-alanine, alpha-ketoglutaric acid, pyruvate oxidase, horseradish peroxidase, 4-amino antipyrine, and N,N-dimethylaminobenzoic acid. The AST zone may contain cysteine sulfonic acid, alpha-ketoglutaric acid and methyl green dye. The layers of patterned paper may be adhered to a bottom layer consisting of patterned channels. The channels in this design may have anti-ALT and anti-AST antibodies immobilized to the paper fibers that form the channels. In this way, a blood sample may be introduced to the filter membrane, wick down to the two reagent zones where reagents for each assay are released from the paper, and then begin to wick down the corresponding channels. As the sample (now containing reagents) wicks down the channel, the AST or ALT may be captured by the antibodies. The more ALT or AST present in the sample, the further down the channel it will be present as it is captured. In this manner, the colorimetric reaction will only proceed in the presence of ALT or AST and therefore will yield a “thermometer” type readout whereby higher amounts of ALT or AST will give color further down the channel. Theoretical outcomes are shown in FIG. 10 for normal, elevated, and highly elevated levels of AST and ALT.

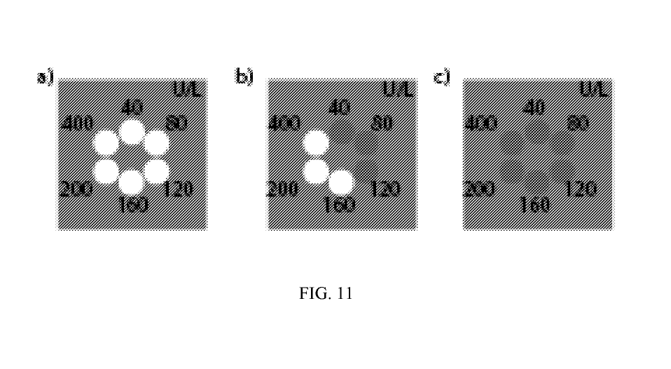

In another notional embodiment of the present invention, a test device comprises multiple output zones. Each zone may be spotted with the same reaction chemistry but in progressively higher concentrations. The concentrations may be chosen such that increasingly higher levels of analyte may be needed to induce a color change in each zone. Thus, the number of zones “activated” will correlate to the amount of analyte in a given sample, resulting in a quantitative readout. An illustration of this embodiment is shown in FIG. 11. For example, in a six zone readout, a sample with normal concentration would have no zones displaying color (FIG. 11, panel A); at elevated concentrations, zones 1-3 would show color (FIG. 11, panel B); and at highly elevated concentrations, all 6 zones would show color (FIG. 11, panel C).

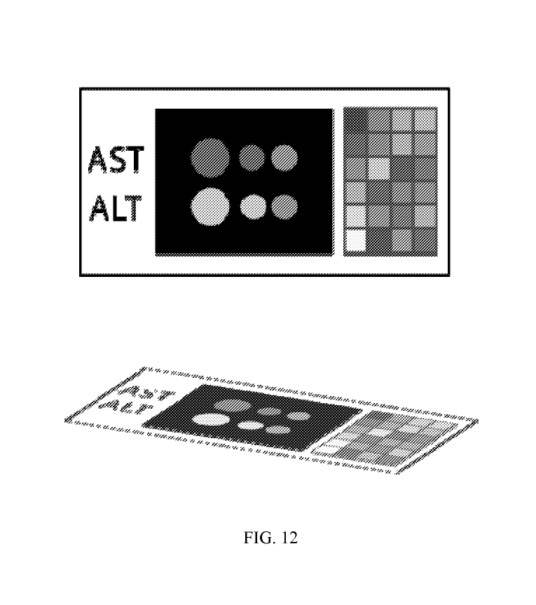

In some embodiments of the present invention, the colorimetric output of the device may be read and interpreted using a cellular phone. While the liver function test will have high utility when read by eye, using color intensity analysis software to interpret results enables one to achieve extremely high resolution—even approaching that of an automated method. In addition, interpretation of colorimetric data by this method provides other advantages such as automating inclusion of results in an electronic medical record and facilitating easy transmission for medical decision-making A telemedicine application would also obviate any concerns about color-blind users. A further embodiment of the current invention is the use of cellular phones and accompanying software to meet the following requirements: (i) the system must work on a basic camera phone (such as those common to the developing world); (ii) the data gathered by the camera must not be sensitive to camera angle, lighting, or distance from the lens. In preferred embodiments, the paper device contains a color chart which the phone software is able to use for automated calibration (FIG. 12); and (iii) the system should be able to automatically recognize the pattern of test zones on the device to minimize user burden. In further embodiments, the device used to record the image is not a cell phone but any device capable of reflectance-based measurement and transmission.

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

The abbreviation “PEG” refers to polyethylene glycol. The abbreviation “EDTA” refers to ethylenediaminetetraacetic acid. The abbreviation “PVA” refers to polyvinyl alcohol. The abbreviation “PBS” refers to phosphate buffered saline. The abbreviation “BSA” refers to bovine serum albumin.

### EXAMPLES

The invention now being generally described, will be more readily understood by reference to the following examples, which are included merely for purposes of illustration of certain aspects and embodiments of the present invention, and are not intended to limit the invention.

### Example 1

### Fabrication of a Five-Zone Device

### Materials

### ALT Assay:

Alanine Solution: A solution containing 1M L-alanine (Sigma Aldrich), 30 mM alpha-ketoglutaric acid (Sigma Aldrich), 2 mM KH₂PO₄ (Sigma Aldrich), 20 mM MgCl₂ (Sigma Aldrich), 2 mM Thiamine Pyrophosphate (MP Biosciences), 2 mM of 4-aminoantipyrine (Sigma Aldrich) and 25 U/mL (0.1 mg/mL) Horseradish Peroxidase (HRP) (Sigma Aldrich) was prepared in 200 mM Tris buffer (pH=7.4).

DABA Solution: A solution containing 10 wt % PEG (MW=35,000 g/mol, Sigma Aldrich) and 10 mM dimethylaminobenzoic acid was prepared in DI water.

Pyruvate Oxidase: A solution containing 100 U/mL of Pyruvate Oxidase (MP Biosciences, EMD) was prepared in 200 mM Tris buffer pH=7.4.

PEG Solution: A solution containing 5 wt % PEG (MW=35,000 g/mol, Sigma Aldrich) was prepared in DI water.

### AST Assay:

PVA Solution: A solution containing 2 wt % of PVA (87-90% Hydrolyzed, MW=13,000-23,000 g/mol, Sigma Aldrich) and 0.05% of Triton X 100 (Sigma Aldrich) was prepared in DI water.

Tris Buffer (400 mM): A solution of 4.8456 g Tris Base (Sigma Aldrich) in 100 mL DI H₂O (pH=8.0) was prepared.

EDTA: A 10 mL solution containing 0.75 g EDTA (Sigma Aldrich) in 400 mM Tris Buffer and the pH was adjusted to 8.0.

Phosphate Buffer (40 mM): A 100 mL solution containing 0.038 g NaH₂PO₄.H₂O (Sigma Aldrich), 1 g Na₂HPO₄.7H₂O (Sigma Aldrich), and 0.387 g of NaCl was prepared and the pH was adjusted to 8.0.

Methyl green Solution: A 1.2% solution of methyl green was prepared by dissolving 0.6 g of methyl green into 50 mL of the PVA solution (prepared above).

Rhodamine B Solution: A 1.2% solution of Rhodamine B was prepared by dissolving 0.6 g of Rhodamine B into 50 mL of the PVA solution (prepared above).

AST Dye Solution: A solution containing 0.6% Methyl Green and 0.05% Rhodamine B in 1% PVA was prepared by combining 600 μL of methyl green solution with 100 μL of rhodamine B solution and 500 μL of 1% PVA solution.

CSA Solution: 171.1 mg CSA (Sigma Aldrich), 14.6 mg alpha-ketoglutaric acid and 10 μL of 200 mM EDTA solution was prepared in 1 mL of 40 mM Phosphate Buffer and the pH was adjusted to 8.0.

AST Positive Control Solution (200KU/L AST solution, 5 wt % PEG, in 1×PBS): A solution was prepared containing 5 wt % PEG (MW=35,000 g/mol, Sigma Aldrich) in 1×PBS and 6.17 μL AST (5177 U/mL, MP Biosciences) were added to make 200 KU/L AST solution. This step was done immediately prior to device fabrication.

### Methods

### Device Fabrication

Device patterns were designed using Adobe Illustrator CS3. A sheet of Whatman No. 1 chromatography paper (8.5×11″) was fed into a laser printer (HP Color Laserjet 4520) and yellow stripes were printed on the back of the sheet to align with the ALT zones. A wax pattern for the top layer (layer from which the device is read) of devices was printed onto this sheet using a Xerox 8560DN printer such that the wax was printed on the opposite side of the yellow stripe. The sheet was heated in the oven at 150° C. for 30 seconds to ensure the wax migrated through the thickness of the paper. A wax pattern for the bottom layer of devices (layer which receives filters) was printed onto Whatman No. 1 Chromatography paper using a Xerox 8560DN printer. This sheet was also heated in an oven at 150° C. for 30 seconds to ensure the wax migrated through the thickness of the paper.

A pressure-sensitive adhesive (UNITAK 131, Henkel) was applied to the back of the top layer by screen printing. The printing screen was patterned using known methods with photocurable emulsion (Atlas Screen Printing Supply) such that the 5 active zones of the device did not receive adhesive but the remaining areas did. The layer was placed in an oven set at 70° C. for 15 min to drive off water from the adhesive leaving behind a patterned, tacky layer of adhesive with “holes” over the zones. This screen-printing process was repeated on the back of the bottom layer. The sheets were then taped to a plastic frame in order to spot reagents.

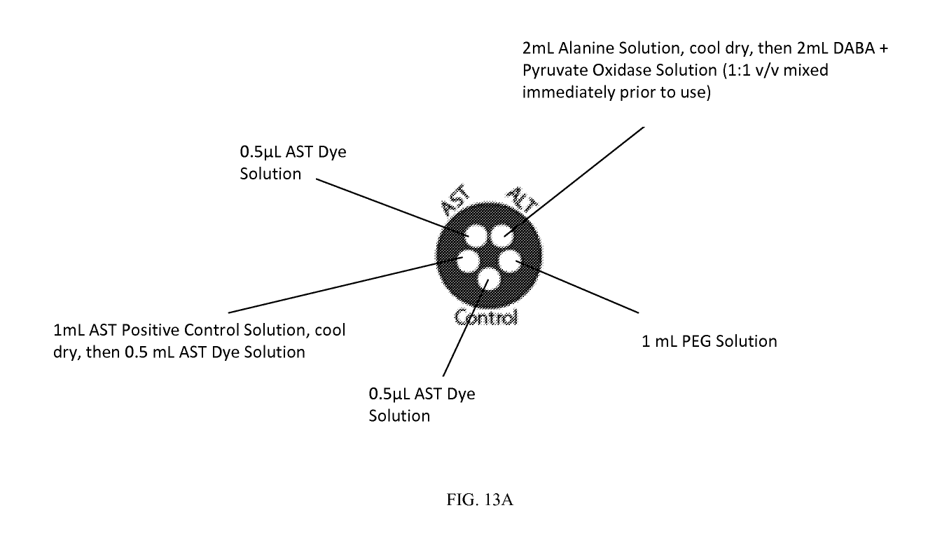

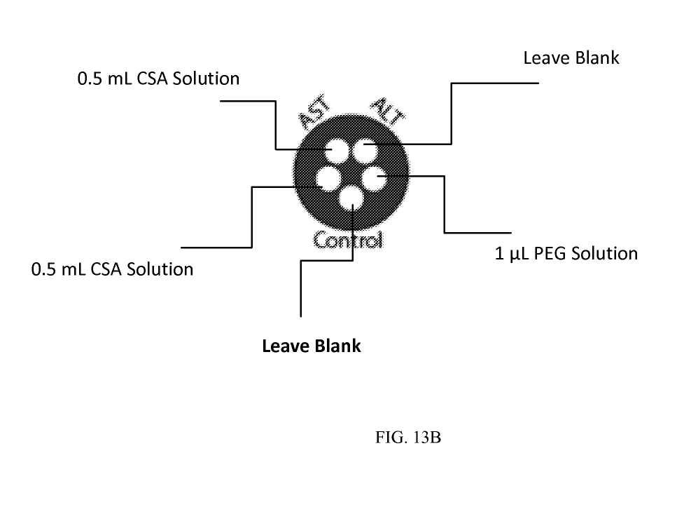

Zones were spotted using a micropipette according to FIGS. 13A and 13B. If multiple spots were required, the first spot was allowed to dry completely (air dry at room temperature) before applying the second.

A hole-puncher was used to punch alignment holes (pre-printed on the corners of each sheet) in both device layers. Device layers were aligned by aligning the previously punched holes. The aligned layers were then sandwiched between two non-adhesive waxy sheets and passed through a laminator at a speed of 2 ft/min. Cold lamination (Fellowes self-adhesive laminate sheets) was then placed on the front face of the sheet of devices. A second sheet of Fellows laminate was cut or punched with 7 mm holes and placed on a bench adhesive side up. 1 cm pre-cut discs of Pall Vivid GX plasma separation membrane were then centered over the holes in the laminate sheet in such a way that the rough side of the membrane was in contact with the adhesive. This process was repeated until each device had a corresponding filter. The cut laminate with adhered filters was then aligned and laminated to the back of the device sheet stack such that each filter covered all 5 zones of the device. Finally, the entire stack was laminated a total of 8 times (4 times with each side facing up) to ensure good contact. Individual devices were then cut by hand and stored in heat-sealed foil-lined bags containing 1 packet of silica desiccant with 10 devices/bag.

### Example 2

### Buffer Testing

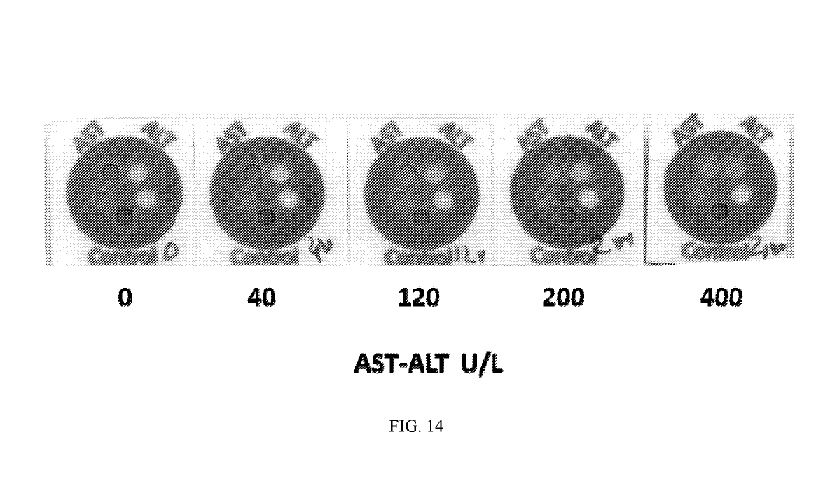

An artificial blood plasma buffer containing 84% (w/v) NaCl, 4% (w/v) NaHCO₃, 2% (w/v) KCl, 2% (w/v) Na₂HPO₄.3H₂O, 3% (w/v) MgCl₂.6H₂O, 3% (w/v) CaCl₂, 1% (w/v) Na₂SO₄, and 7% (w/v) bovine serum albumin was prepared in DI water and the pH was adjusted to 7.4. Stock solutions containing 0, 40, 120, 200, and 400 U/L of both ALT and AST were prepared in the artificial blood plasma buffer. 30 μL of each of these solutions were added to 5 individual devices. The devices were allowed to react for 15 minutes and were scanned using a desktop scanner (Canon). The resulting image (FIG. 14) showed a gradation of color from yellow to red for the ALT assay with increasing ALT and a gradation of color from dark blue to pink in the AST assay with increasing AST.

### Example 3

### Limit of Detection

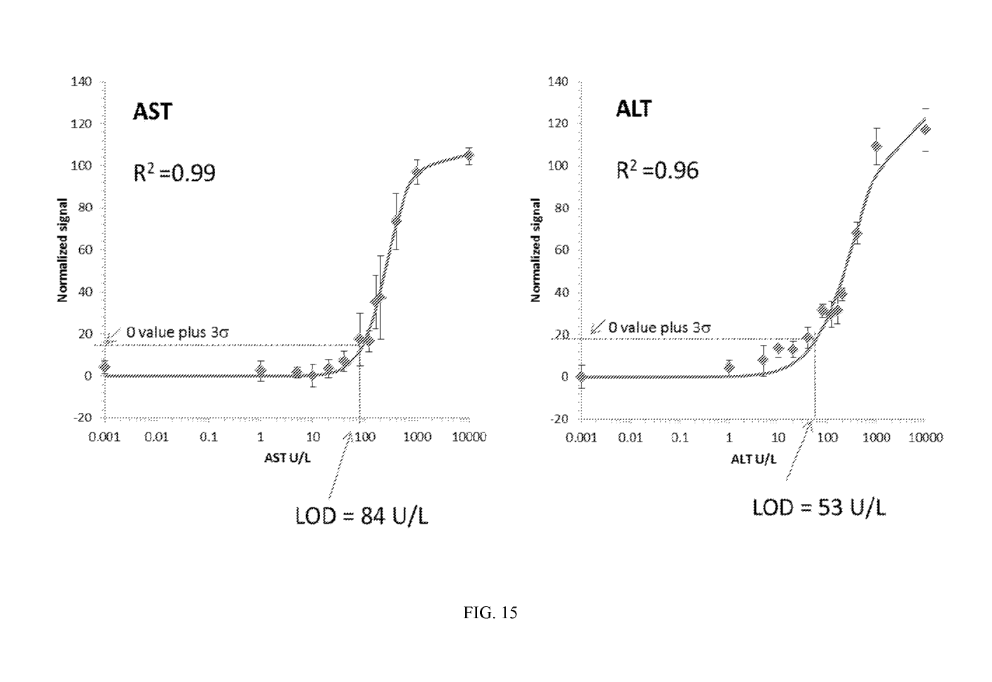

Limit of detection (LOD) curves were generated for the AST and ALT assays using standard statistical methods. Color intensity was quantified in each zone by using desktop scanner to digitize the image and analysis software (ImageJ) to obtain a value. A calibration plot of the output signal of LFT versus the concentration of AST or ALT in the buffer sample (N=7 for each concentration) is shown in FIG. 15. For AST, the solid line represents a non-linear regression of Hill Equation: I=Iₘₐₓ[L]ⁿ/([L]ⁿ+[L₅₀]ⁿ), where Iₘₐₓ=105.7, [L₅₀]=260.9 U/L, n=1.72, and R²=0.99. The error bars represent one standard deviation (a). For ALT, the solid line represents a non-linear regression of Hill Equation: I=Iₘₐₓ[L]ⁿ/([L]ⁿ+[L₅₀]ⁿ), where Iₘₐₓ=126.5, [L₅₀]=331.33 U/L, n=1.04, and R²=0.96. The error bars represent one standard deviation (a). For both assays the linear portion of the sigmoidal curve ranges approximately within the concentrations of 40-200 U/L. The calculated LOD was 53 U/L for the ALT assay and 84 U/L for the AST assay. These values matched well with the lowest concentrations of ALT and AST that generated visible color change when compared to normal levels.

### Example 4

### Repeatability

To measure repeatability of the paper-based transaminase test, color intensity was measured (scanner/ImageJ analysis) on samples containing normal and elevated levels of AST and ALT. A total of 10 devices were used to measure each sample. Variation was determined from the coefficient of variation (% CV), defined as the standard deviation divided by the mean, for each sample. The results (Table 1) indicate CV's were less than 10% for both AST and ALT tests in all four conditions tested (elevated/normal serum and blood).

TABLE 1

| | | Serum | Serum | | |
|---|---|---|---|---|---|
| | | Standard | Standard | Whole Blood | Whole Blood |
| | | Level 1 | Level 2 | Level 1 | Level 2 |
| | | ALT = 56 U/L | ALT = 128 U/L | ALT = 40 U/L | ALT = 200 U/L |
| | | AST = 69 U/L | AST = 244 U/L | AST = 40 U/L | AST = 200 U/L |
| Alanine | Color | | | | |
| Aminotransferase | Intensity | | | | |
| (ALT) | Mean ± S.D. | 111.0 ± 6.55 | 120.6 ± 11.2 | 93.6 ± 4.75 | 146.5 ± 10.59 |
| | % CV | 5.89 | 9.28 | 5.08 | 7.22 |
| Aspartate | Color | | | | |
| Aminotransferase | Intensity | | | | |
| (AST) | Mean ± S.D. | 62.6 ± 5.52 | 151.1 ± 7.60 | 65.3 ± 5.24 | 168.5 ± 4.45 |
| | % CV | 8.82 | 5.03 | 8.01 | 2.64 |

### Example 5

### Linearity Testing with Whole Blood

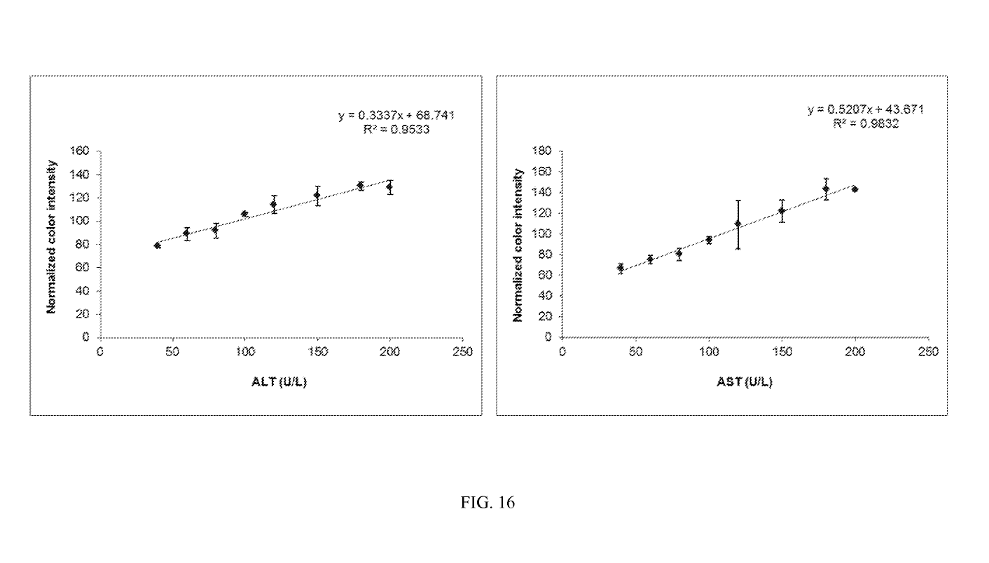

Linearity of the test was measured by adding known amounts (0, 40, 60, 80, 100, 120, 150, 180, 200, 300, and 400 U/L) of purified ALT and AST to fresh whole blood (obtained by venipuncture), pipetting 30 μL of blood onto the device and digitizing the color reactions observed after 15 minutes using a desktop scanner (FIG. 17). Image analysis software (ImageJ, NIH) was used to translate the resulting color intensities in each scanned zone into quantitative values. These values were plotted against actual concentrations to obtain a standard curve (FIG. 16). Strong linearity was observed for both assays across the clinically relevant range (40 to 200 U/L). R-squared values of 0.95 and 0.98 were measured for the ALT and AST plots, respectively (N=3 for each data point, error bars represent +/−1 standard deviation).

### Example 6

### Clinical Specimen Testing

In order to gauge accuracy of the paper-based transaminase test with respect to the ability of a reader to correctly place values measured in a given sample in the appropriate bin (<3×ULN (0-119 U/L), 3-5×ULN (120-200 U/L), or >5×ULN (>200 U/L), a set of clinical specimens was tested. For these experiments, 30 μL aliquots of paired whole blood and serum specimens were tested that had been drawn (in standard EDTA-containing and serum separator tubes, respectively) simultaneously from patients within the previous 5 hours for routine clinical testing and for which results of automated transaminase testing (Roche Modular Analytic System) of the serum specimen were available (of note, previous studies showed that EDTA did not interfere with the paper-based assays). Each paper assay was read visually after 15 minutes by three independent readers who were blinded to automated results; each independently matched test zone colors to the closest color/value found on the read guide and recorded a result in U/L (rounded to the nearest 10 U/L).

Bin placement accuracy was measured by determining if each data point met at least one of the following criteria: i) the value measured by the paper transaminase test was within the correct bin as determined by the automated (true) value, or ii) the value measured by the paper test was within 40 U/L of the true value. The second criterion accounts for values near the boundaries of the bins as it was agreed that variations of <40 U/L were clinically acceptable as they were unlikely to reflect differences in clinical status of the patient. A summary of the bin placement accuracy data is seen in Table 2. Overall accuracies for the device were above 90% for both AST and ALT in both serum and whole blood. Additionally, “per bin” accuracies were calculated by dividing the number of correctly binned samples in each bin by the total number of samples in that bin. The data reveal that ALT accuracies were higher for serum than for whole blood, particularly in the 3-5× bin (92% vs 57%, respectively). This disparity can be explained by the age of the whole blood (2-5 hours, i.e., drawn from patient 2-5 hours prior) at the time of testing. In early experiments (data not shown), it was found that whole blood samples yielded artificially high ALT values after aging for >3 hours from time of draw. It is believed that this is due to the fact that over time, red blood cells (RBCs) release lactate which is converted to pyruvate; pyruvate leads to activation of the ALT assay and therefore falsely high readings. In the case of serum, RBCs are separated from the serum shortly after draw, preventing accumulation of pyruvate in serum. Therefore, accuracies from fresh whole blood (i.e., from fingerstick) are expected to mirror the serum results in this study.

TABLE 2

| | | | No. of | No. | | |
|---|---|---|---|---|---|---|
| | | Bin (X = 40 U/L = | Samples in | Correctly | “Per Bin” | Overall |
| Test | Specimen | ULN) | bin | Placed | Accuracy | Accuracy |
| ALT | Serum | 1-3X | 89 | 88 | 99% | 95% |
| | | 3-5X | 12 | 11 | 92% | |
| | | >5X | 19 | 15 | 79% | |
| | Blood | 1-3X | 70 | 66 | 94% | 90% |
| | | 3-5X | 7 | 4 | 57% | |
| | | >5X | 11 | 9 | 82% | |
| AST | Serum | 1-3X | 88 | 85 | 97 | 91% |
| | | 3-5X | 26 | 18 | 69% | |
| | | >5X | 14 | 14 | 100% | |
| | Blood | 1-3X | 69 | 68 | 99% | 94% |
| | | 3-5X | 17 | 13 | 76% | |
| | | >5X | 8 | 7 | 88% | |

### Example 7

### Fingerstick Testing

Experiments were conducted to observe the performance of the device with whole blood obtained via fingerstick. In a small study, 10 healthy volunteers each used a lancet (SurgiLance™ SLN300) to obtain a droplet (˜30 μL) of blood from a finger and introduced it to the device (e.g., as shown in FIG. 1). 10/10 devices were found to fully activate, meaning that all zones were wet with plasma, and all controls worked properly. As expected, AST and ALT levels were found to be in the normal range (<60 U/L) for this group.

### INCORPORATION BY REFERENCE

The entire disclosure of each of the patent documents and scientific articles referred to herein is incorporated by reference for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. A test device for quantitative determination of an analyte in a liquid biological sample, the device comprising
a porous, hydrophilic sheet defining plural functional regions including:
a liquid sample input;
a colorimetric test readout;
a negative control that upon absorption of the sample maintains or displays a predetermined color;
a positive control, and
a liquid flow path which, responsive to application of a liquid sample to said input, transports liquid between said input and said readout and controls;
disposed in said device, at least one dried, color-producing reagent arranged to produce a shade or pattern of color in a said readout as a function of the concentration of an analyte in the sample; and
disposed in said device, a dried, color-producing reagent which reacts at said positive control to produce color;
wherein a valid test is indicated by color change in said positive control and maintenance or display of a predetermined color at said negative control.

2. A test device for quantitative determination of an analyte in a liquid biological sample, the device comprising
a porous, hydrophilic sheet defining plural functional regions including:
a liquid sample input;
a colorimetric test readout including a region of a color backing said readout which optically interacts with color developed at said readout to improve visual discrimination among different analyte concentrations in an applied sample;
a colorimetric control;
a liquid flow path which transports liquid between said input and both said readout and control; and,
disposed in said device, a dried, color-producing reagent which, responsive to application of a liquid sample to said input, is entrained and reacts with an analyte, if present in said sample, to produce a shade of color in a said readout as a function of the concentration of an analyte in the sample.

3. The device of claim 1 comprising a plurality of sheets disposed parallel to one another, at least two of which are separated by a liquid impermeable barrier layer defining an opening permitting liquid flow communication between said sheets.

4. The device of claim 1 comprising a region of a color backing said readout which optically interacts with color developed at said readout to improve visual discrimination among different analyte concentrations in an applied sample.

5. The device of claim 1 wherein said color-producing reagent reacts with a liver enzyme.

6. The device of claim 5 wherein the sample is a blood sample suspected to contain elevated concentrations of aspartate aminotransferase, alanine aminotransferase, or a mixture thereof.

7. The device of claim 1 comprising a negative control comprising a colored area applied to a said sheet which has an appearance when wetted different from when dry.

8. The device of claim 1 wherein said readout comprises an area of a said sheet comprising an immobilized binder which captures a colored species produced by said color-producing reagents and the concentration of analyte in a said sample is indicated by the portion of said area that develops color responsive to application of liquid to said input.

9. The device of claim 8 wherein the area is continuous and the concentration of analyte in a said sample is indicated by linear extent of color development in said continuous area.

10. The device of claim 8 wherein the area comprises a plurality of separate areas and the concentration of analyte in a said sample is indicated by the number of areas that develop color.

11. The device of claim 1 further comprising a region defining a timer comprising a reservoir disposed in said device in liquid communication with said input which after application of a sample is fed with liquid over a predetermined time interval and comprises indicia that the reservoir is filled and the device is ready to be read.

12. The device of claim 11 wherein said timer comprises a channel of predefined dimensions which determines the length of time that liquid takes to reach said reservoir and to activate said indicia.

13. The device of claim 11 wherein said indicia is a printed message visible when the device is ready to be read.

14. The device of claim 11 wherein said timer also functions as a positive colorimetric control.

15. The device of claim 11 wherein said reservoir is disposed downstream from said readout.

16. The device of claim 1 further comprising a filter disposed downstream of said sample input.

17. The device of claim 1 further comprising downstream of the color-producing reagent and upstream of the colorimetric test readout, a dwell region which transports therethrough a mixture of the analyte and the color-producing reagent, the dwell region comprising a multiplicity of micro flow paths including hydrophobic flow impeding surfaces, the numbers and dimensions of the micropaths serving to set the incubation time within a predetermined time interval as the mixture passes therethrough.

18. The device of claim 17 wherein the dwell region is impregnated with a hydrophobic material which impedes the rate of liquid passage through the dwell region.

19. The device of claim 18 wherein said dwell region is manufactured by printing a hydrophobic material onto a surface of a said sheet and heating to absorb the hydrophobic material into the pores of said sheet.

20. The device of claim 17 further comprising an immobilized binder at said colorimetric test readout for capturing a complex formed during incubation in said dwell region.

21. The device of claim 17 further comprising an adsorptive reservoir downstream of said colorimetric test readout for drawing liquid along said flow path and through said dwell region and colorimetric test readout thereby to remove unbound colored species from the colorimetric test readout.

22. The device of claim 17 further comprising a sheet holding a said dried, color-producing reagent in fluid communication with a parallel disposed sheet defining said dwell region.

23. The device of claim 17 wherein at least two of the following elements of said device are defined on a single said porous, hydrophilic sheet: a region holding a dried, color-producing reagent; a sample input; a colorimetric test readout; a dwell region; and an adsorptive reservoir.

24. The device of claim 3 comprising a patterned layer of adhesive comprising said barrier layer defining an opening permitting liquid flow communication between said sheets.

25. The device of claim 3 wherein said sample input and said readout are disposed on different said sheets.

26. The device of claim 3 wherein said readout and a said dried, color-producing reagent are disposed on different said sheets.

27. The device of claim 1 further comprising a color chart relating color at said readout to analyte concentration.

28. The device of claim 27 wherein said color chart is integrated with a said sheet.

29. The device of claim 1 comprising plural readouts serviced by respective different dried, color-producing reagents.

30. The device of claim 1 wherein said flow path comprises one or a pattern of hydrophilic channels which direct transport of liquid flow and are defined by liquid impermeable boundaries substantially permeating the thickness of the hydrophilic sheet.

31. The device of claim 1 further comprising an electrode assembly comprising one or more electrodes in liquid flow communication with said input region.

32. A method of manufacturing test devices for determination of one or more analytes in a liquid biological sample, the method comprising:
a. providing a first porous, hydrophilic sheet which supports absorptive flow transport;
b. printing onto said sheet an array of test device elements respectively comprising a pattern of hydrophobic barriers permeating the thickness of the porous sheet to define respective said elements, each of which comprise plural functional regions including:
a liquid flow path; and
a colorimetric test readout;
c. laminating to the first sheet a second porous, hydrophilic sheet to form a laminate; and
d. cutting the laminate to separate individual said elements to form a multiplicity of functional test devices.

33-45. (canceled)
